(19) United States
(12) Patent Application Publication
(10) Pub. No.: US 2023/0076787 A1
(43) Pub. Date: Mar. 9, 2023

(54) CODE ACQUISITION SYSTEM AND METHOD

(71) Applicant: CHANGXIN MEMORY TECHNOLOGIES, INC., Hefei City, Anhui (CN)

(72) Inventor: YuLang CHEN, Hefei City, Anhui (CN)

(21) Appl. No.: 17/438,455

(22) PCT Filed: May 28, 2021
(86) PCT No.: PCT/CN2021/096650

§ 371 Date: Sep. 12, 2021

(30) Foreign Application Priority Data
May 29, 2020 (CN) 202010475264.8
May 25, 2021 (CN) 202110574189.5

(51) Int. Cl. G06T 7/11; H04N 5/225; H04N 5/262; H04N 5/232; G06K 7/14

(52) U.S. Cl. CPC G06T 7/11; H04N 5/2256; H04N 5/2628; H04N 5/23203; G06K 7/1417; G06K 7/1447; G06T 2207/20021; G06T 2207/20132

(57) ABSTRACT

The present application relates to a code acquisition system and method. The code acquisition system comprises a transfer track; an image capture device and an image processing device. The image capture device is configured to capture memory stick images. The code area definition module in the image processing device is configured to divide into code areas according to the types, sizes and positions of pre-loaded memory stick codes. The code identification module identifies the memory stick codes according to the memory stick images and the code areas.

### CROSS-REFERENCE TO RELATED APPLICATIONS

The present application claims the priority to Chinese Application 202010475264.8, titled “CODE ACQUISITION SYSTEM AND METHOD”, filed on May 29, 2020, and Chinese Application 202110574189.5, titled “CODE ACQUISITION SYSTEM AND METHOD”, filed on May 25, 2021, which are incorporated herein by reference in their entireties.

### TECHNICAL FIELD

The present application relates to a code acquisition system and method.

### BACKGROUND

In the traditional solutions, when a code scanning device is manually operated to acquire codes on a dual inline memory module (DIMM), only one code may be acquired at a time. Therefore, it needs nine or more code scanning operations to obtain all codes on a DIMM. The code acquisition efficiency is low.

### SUMMARY

The present application relates to a code acquisition system and method.

According to various embodiments, a first aspect of the present application provides a code acquisition system, comprising:

a transfer track, configured to transfer memory sticks and limit the positions and placement directions of the memory sticks;

an image capture device, configured to capture memory stick images; and

an image processing device, comprising: a code area definition module configured to divide into code areas according to types, sizes and positions of pre-loaded memory stick codes; and a code identification module electrically connected to the image capture device and the code area definition module respectively, and configured to receive the memory stick images and identify the memory stick codes according to the memory stick images and the code areas.

According to various embodiments, a second aspect of the present application provides a code acquisition method, comprising:

pre-loading the types, sizes and positions of memory stick codes;

dividing into code areas according to the types, sizes and positions of the memory stick codes;

transferring memory stick to preset positions;

capture memory stick images; and

identifying the memory stick codes according to the code areas and the memory stick images.

The details of one or more embodiments of the present application will be set forth in the following drawings and description. Other features and advantages of the present application will become apparent from the description, drawings and claims.

### BRIEF DESCRIPTION OF THE DRAWINGS

In order to explain technical solutions of embodiments of the present application or in the prior art more clearly, the drawings to be used for describing the embodiments or the prior art will be introduced simply. Apparently, the drawings to be described below are merely some embodiments of the present application, and a person of ordinary skill in the art may further obtain other drawings according to these drawings without paying any creative effort.

FIG. 1 is a schematic structure diagram of a code acquisition system according to an embodiment of the present application;

FIG. 2 is a schematic diagram of code areas on a DIMM stick according to an embodiment of the present application;

FIG. 3 is a schematic diagram of the placement direction of a memory stick on the transfer track in the code acquisition system according to an embodiment of the present application;

FIG. 4 is a schematic diagram of the electrical connection structure of an image processing device in the code acquisition system according to an embodiment of the present application;

FIG. 5 is a schematic diagram of the electrical connection structure of the code acquisition system according to an embodiment of the present application;

FIG. 6 is a schematic diagram of the corresponding storage relationship between the control process and the database form in the code acquisition system according to an embodiment of the present application;

FIG. 7 is a flowchart of the control process of the code acquisition system according to an embodiment of the present application; and

FIG. 8 is a flowchart of a memory stick code acquisition process of the code acquisition system according to an embodiment of the present application.

### REFERENCE NUMERALS

100: code acquisition system; 10: transfer track; 20: image capture device; 30: image processing device; 310: code area definition module; 320: code identification module; 321: image magnification unit; 322: image identification unit; 323: image cutting unit; 324: image preprocessing unit; 325: image binarization unit; 40: illuminating device; 50: process control device; 510: process control module; 520: data integration module; 60: data storage device.

### DETAILED DESCRIPTION

In order to make the above objectives, features and advantages of the present application more obvious and understandable, the specific implementations of the present application will be described in detail below with reference to the accompanying drawings. In the following description, many specific details are provided in order to fully understand the present application. However, the present application may be implemented in many other ways different from those described herein, and those skilled in the art can make similar improvements without departing from the spirit of the present application. Therefore, the present application is not limited by the specific implementations disclosed below.

It is to be noted that when an element is referred to as being “fixed to” another element, it may be located on the another element directly or with intervening elements therebetween. When an element is referred to as being “connected to” another element, it may be connected to the another element directly or with intervening elements therebetween.

Unless otherwise defined, all technical and scientific terms used herein have the same meaning as commonly understood by a person of ordinary skill in the art to which the present application belongs. Here, terms used in the description of the present application are merely intended to describe specific embodiments, rather than limiting the present application. As used herein, the term “and/or” includes any or all of one or more associated listed items or combinations thereof.

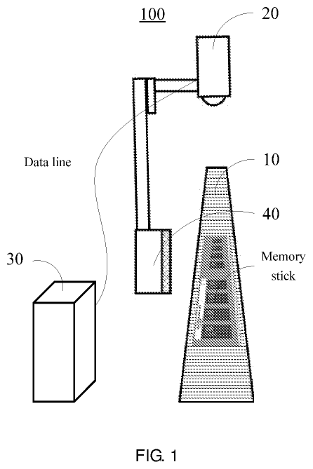

Referring to FIG. 1, the present application provides a code acquisition system 100. The code acquisition system 100 comprises a transfer track 10, an image capture device 20 and an image processing device 30.

The transfer track 10 is configured to transfer memory sticks and limit the positions and placement directions of the memory sticks.

The image capture device 20 is configured to capture memory stick images.

The image processing device 30 comprises: a code area definition module configured to divide into code areas according to types, sizes and positions of pre-loaded memory stick codes; and a code identification module electrically connected to the image capture device and the code area definition module respectively, and configured to receive the memory stick images and identify the memory stick codes according to the memory stick images and the code areas.

It may be understood that the code acquisition system 100 according to the present application is not limited to the acquisition of memory stick codes, and may be applied to other products that require code acquisition. Meanwhile, the type of the memory stick codes is not limited in the present application. The format of the codes may include, but is not limited to, code-128, data matrix, QR-code. In an embodiment, the memory stick may be, but is not limited to, a DIMM stick. Since the codes on the DIMM stick include DIMM bar codes and chip two-dimensional codes, the code dimension of the DIMM stick may include one-dimensional codes and two-dimensional codes. In an embodiment, the open source code acquisition libraries pylibdmtx and pyzbar may be used to realize the identification of various memory stick codes.

In an embodiment, since the number of codes and the position of the codes on different types of memory sticks may be different, when transferring the memory sticks by the transfer track 10, the position and placement direction of the memory sticks may be preset on the transfer track 10 according to the number of codes and the position of the codes on the memory sticks of the current type. In this embodiment, the direction of the length of the memory stick may be the direction of movement of the transfer track 10. The memory sticks of the same type are placed in the same direction, and the distance between two ends of the memory sticks of the same type in the width direction of the transfer track 10 is constant. It may be understood that, by providing the transfer track 10, the difference in the position of codes on the memory sticks of the same type may be reduced, and the accuracy of code identification by the code acquisition system 100 may be improved.

In an embodiment, the image capture device 20 may include, but is not limited to, a camera. In this embodiment, the frame rate of the camera used may be equal to or greater than 25 FPS, and the resolution of the captured memory stick image may be equal to or greater than 1080p (1920×1080). In addition, the camera lens may be selected according to the actual situation, as long as the camera lens can capture all the codes on the memory stick.

In an embodiment, the image processing device 30 can identify various code formats such as the aforementioned code-128, data matrix and QR-code, and code positions. The code area definition module 310 may divide into code areas in any number and position according to the type, size and position of the pre-loaded memory stick codes. That is, the code area definition module 310 may automatically obtain, according to the type of memory sticks from which codes are to be acquired pre-input by a human-computer interaction device, the type, size, and position of the memory stick codes on the memory sticks of this type, so as to divide into the code areas according to the above information.

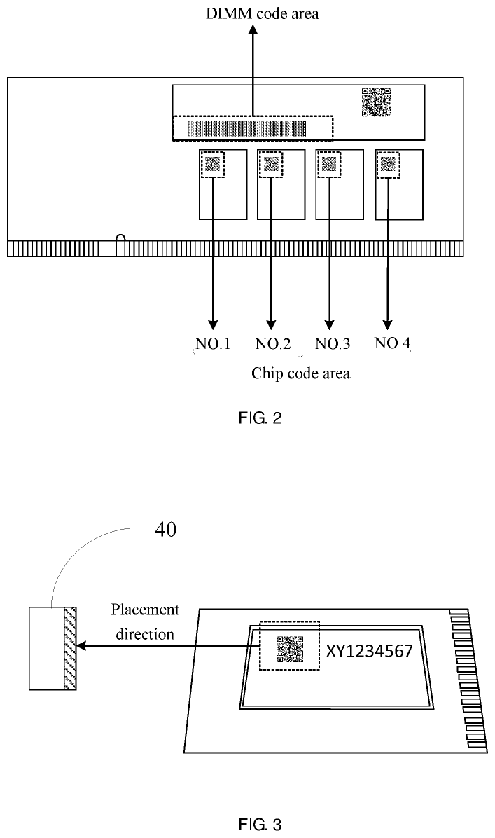

Referring to FIG. 2, in an embodiment, the code area definition module 310 may number the divided code areas of a same type while dividing into code areas according to the type, size, and position of the pre-loaded memory stick codes, and identify the memory stick codes in different code areas in sequence according to the numbering sequence. It may be understood that, by dividing the memory stick codes on the memory sticks of a same type into code areas, and by numbering the code areas and ensuring that the position and placement direction of the memory stick codes with the same number are the same on the memory stick image, the identification accuracy of the memory module codes can be improved. In an embodiment, the defined code areas and their corresponding numbers may be saved as a code area distribution scheme. In this way, during the subsequent acquisition, the codes on the memory sticks of this type may be quickly loaded, without the need to re-divide into code areas. It may be understood that the division and numbering of code areas can ensure the targeted identification of different codes on the memory sticks, thereby improving the identification accuracy of the memory stick codes.

The code acquisition system 100 according to the present application comprises a transfer track 10, an image capture device 20 and an image processing device 30. Transferring memory sticks by the transfer track 10 can speed up the identification of the memory stick codes, and meanwhile, limiting the position and placement direction of the memory sticks by the transfer track 10 can improve the identification accuracy of the memory stick codes. The image capture device 20 is configured to capture a memory stick image. The image processing device 30 comprises a code area definition module 310 and a code identification module 320. The code area definition module 310 is configured to divide into code areas according to the type, size and position of pre-loaded memory stick codes. The setting of the code areas is helpful to the targeted identification of multiple codes on the memory stick. The speed of code identification and the accuracy of code identification by the code acquisition system 100 can be improved. The code identification module 320 is electrically connected to the image capture device 20 and the code area definition module 310, respectively, and is configured to receive the memory stick image and identify the memory stick codes according to the memory stick image and the code areas. It may be understood that the code acquisition system 100 according to the present application can acquire all the codes on the memory stick at a time through one memory stick image, which improves the acquisition efficiency of the memory stick codes.

In an embodiment, the code acquisition system 400 further comprises an illuminating device 40. The illuminating device 40 is configured to provide light for the capture process of the memory stick images.

In an embodiment, the DIMM codes and chip codes in the DIMM stick are both close to the background color. That is, the code contrast is low. In addition, the chip codes are small in size, for example 4 mm×4 mm. Therefore, when identifying the codes on the DIMM stick, the image capture device 20 may not be able to obtain a clear memory stick image. In this embodiment, the illuminating device 40 may be used to provide light for the capture process of the memory stick image. It may be understood that the type and wavelength band of the light source in the illuminating device 40 may be selected according to actual needs. In an embodiment, the illuminating device 40 may be, but is not limited to, a light emitting diode (LED), and its wavelength band may be, but is not limited to, 380 nm to 780 nm, that is, white light. It may be understood that the use of white light for illumination by the illuminating device 40 can ensure the reflection of light by different materials on the DIMM stick, thereby improving the clarity of the DIMM stick image and improving the accuracy of code identification by the code acquisition system 400.

In an embodiment, the light outgoing direction of the illuminating device 40 is parallel to the transfer plane of the transfer track 10 and perpendicular to the extension direction of the transfer track 10.

In an embodiment, the light outgoing direction of the illuminating device 40 is parallel to the transfer plane of the transfer track 10. That is, the light outgoing direction is perpendicular to the normal direction of the surface of the memory stick codes. That is, light irradiates the entire memory stick surface in parallel. It may be understood that, since the light outgoing direction of the illuminating device 40 is parallel to the transfer plane of the transfer track 10, the difference in energy of light reflected by different materials on the memory stick may be maximized, thereby increasing the contrast of the memory stick image. In addition, since the memory stick codes have slight protrusions on the surface of the memory stick and the protrusions will reflect light to a certain extent, designing the light outgoing direction of the illuminating device 40 to be parallel to the transfer plane of the transfer track 10 can also reduce the reflection of light by the protrusions. This can increase the contrast of the memory stick image and improve the identification accuracy of the memory stick codes.

Referring to FIG. 3, In an embodiment, when setting the placement direction of the memory stick, a side of the memory stick having the codes may be arranged close to the illuminating device 40, so as to prevent light parallel to the surface of the memory stick from being blocked by protrusions in non-code-areas. In this embodiment, the DIMM code areas on the DIMM stick may be arranged close to the illuminating device 40.

In an embodiment, the code identification module 320 comprises an image magnification unit 321 and an image identification unit 322.

The image magnification unit 321 is electrically connected to the image capture device 20 and the code area definition module 310, respectively, and configured to magnify the different code areas of the memory stick images to different preset multiples.

The image identification unit 322 is electrically connected to the image magnification unit 321 and configured to identify codes in the different code areas magnified of the memory stick images.

In an embodiment, there are multiple types of memory stick codes on the memory stick, for example bar codes and two-dimensional codes, which are different in size. Therefore, the image magnification unit 321 may magnify the different code areas of the memory stick image to different preset multiples. The preset multiple may be preset according to the type of the memory stick codes. It may be understood that, by providing the image magnification unit 321, the identification accuracy of codes on a small-sized memory stick may be improved.

In an embodiment, the image identification unit 322 can realize targeted identification of the memory stick codes in different code areas. The image identification unit 322 can identify various code formats, including but not limited to code-128, data matrix and QR-code, and code positions. It may be understood that the image identification unit 322 can realize simultaneous identification of the memory stick codes in multiple code areas, which can increase the code identification speed of the code acquisition system 100 and expand the application range of the code acquisition system 100.

In an embodiment, the code identification module 320 further comprises an image cutting unit 323. The image cutting unit 323 is electrically connected to the image capture device 20, the code area definition module 310 and the image magnification unit 321, respectively, and configured to cut the memory stick images according to the code areas and send the cut memory stick images to the image magnification unit 321.

It may be understood that, in each of the acquired memory stick images, the code areas occupy only a small part of the memory stick image, and the remaining non-code-areas do not comprise the code information to be identified. Therefore, by providing the image cutting unit 323, it may be ensured that the image identification unit 322 processes only the code areas. This reduces the computation burden, and avoids the interference of the non-code-areas when the image identification unit 322 identifies the memory stick codes. The code acquisition speed of the code acquisition system 100 and the identification accuracy of the memory stick codes are improved.

In an embodiment, the image cutting unit 323 may first cut the memory stick image captured by the image capture device 20 according to the pre-divided code areas, that is, cut the entire code area image into independent sub-images each comprising one or more memory stick codes. In an embodiment, each sub-image may comprise one memory stick code, so that the image magnification unit 321 separately amplifies each memory stick code. In another embodiment, each sub-image may comprise multiple memory stick codes. In this embodiment, the type of the multiple memory stick codes in a sub-image may be the same. This is because, when the image magnification unit 321 magnifies the memory stick codes, it may magnify the memory stick codes of a same type to a same multiple. Therefore, by cutting the memory stick codes of a same type into one sub-image, the image cutting efficiency may be improved, thereby increasing the code acquisition speed of the code acquisition system 100.

In an embodiment, the code identification module 320 further comprises an image preprocessing unit 324 and an image binarization unit 325.

The image preprocessing unit 324 is electrically connected to the image capture device 20 and the image cutting unit 323, respectively, and configured to convert the memory stick images into grayscale images and send the grayscale images to the image cutting unit 323. In this embodiment, the image preprocessing unit 324 is electrically connected to the image capture device 20 and the image cutting unit 323, respectively. Upon receiving the memory stick image sent by the image capture device 20, the image preprocessing unit 324 converts the memory stick image into a grayscale image and sends the grayscale image to the image cutting unit 323. The image cutting unit 323 is electrically connected to the code area definition module 310, the image preprocessing unit 324, and the image magnification unit 321, respectively, and configured to cut the grayscale image according to the code areas and send the cut grayscale image to the image magnification unit 321. The image magnification unit 321 magnifies the cut multiple grayscale sub-images.

The image binarization unit 325 is electrically connected to the image magnification unit 321 and the image identification unit 322, respectively, and configured to binarize the magnified memory stick images and send the binarized memory stick images to the image identification unit 322.

In an embodiment, since the memory stick codes usually do not comprise color information, converting the memory stick image into a grayscale image by the image preprocessing unit 324 can reduce the amount of data to be processed in the memory stick image. In this way, the identification speed of the memory stick codes by the image identification unit 322 can be improved, without affecting the accuracy of code identification.

In an embodiment, the image binarization unit 325 may obtain an adaptive threshold by the Maximum Between-Class Variance method among binarization methods, and converts grayscale images of the memory sticks into binary images according to the adaptive threshold. It may be understood that, before binarizing the grayscale image of the memory stick, the image magnification unit 321 may be used to magnify the image of the memory stick, so as to improve the binarization accuracy of the image binarization unit 325, that is, the success rate in determining the memory stick codes and the background. It may be understood that providing the image binarization unit 325 can greatly remove non-encoded images, increase the contrast between the memory stick codes and the background in the memory stick image, and improve the identification accuracy of the memory stick codes.

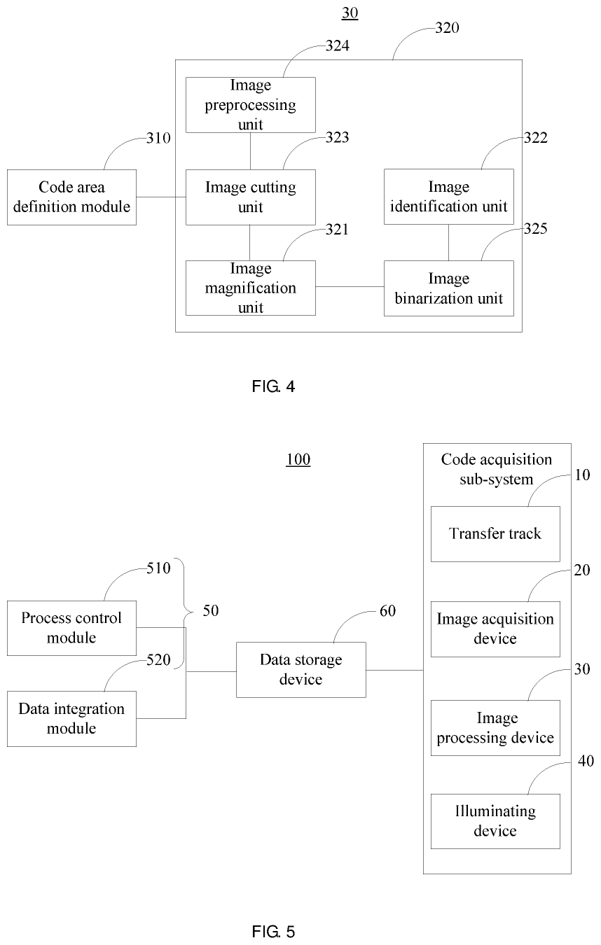

Referring to FIG. 4, in an embodiment, the image preprocessing unit 324 may first convert the memory stick image into a grayscale image, and send the grayscale image to the image cutting unit 323. The image cutting unit 323 may cut the memory stick image according to the pre-divided code areas and send the obtained sub-images to the image magnification unit 321. The image magnification unit 321 may magnify each sub-image to a desired multiple, and send it to the image binarization unit 325 for image binarization processing. Finally, the image binarization unit 325 may send the binarized multiple sub-images to the image identification unit 322 to realize the identification of multiple memory stick codes.

In an embodiment, the code acquisition system 100 further comprises a process control device 50. The process control device 50 is electrically connected to the transfer track 10, the image capture device 20, the image processing device 30, and the illuminating device 40, respectively, and configured to control the transfer track 10, the image capture device 20, the image processing device 30, and the illuminating device 40 to start or stop according to a preset process, receive the identified memory stick codes, and integrate the memory stick codes into a preset form.

In an embodiment, before controlling the transfer track 10, the image capture device 20, the image processing device 30, and the illuminating device 40 to start according to the preset process, the process control device 50 may set the desired startup parameters and load the pre-configured startup parameters.

In an embodiment, the startup parameters may comprise camera parameters (device number and image resolution), system control parameters (state acquisition sensitivity and program running detection), system detection parameters (memory stick code type, memory stick code magnification multiple, and default code areas) and so on. It should be noted that the state acquisition sensitivity may be set by setting the communication between the process control device 50 and the data storage device 60. The higher the communication between the process control device 50 and the data storage device 60 is, the lower the state acquisition sensitivity is. It may be understood that the startup parameters may be set according to actual needs. By setting the startup parameters, the application range of the code acquisition system 100 may be expanded, and the accuracy of the code identification by the code acquisition system 100 may be improved.

In an embodiment, a computer, a screen, a keyboard, and a mouse may be used together as the process control device 50. It may be understood that the code areas may be pre-divided by framing by keys and a mouse. The specific keys used may be set according to actual needs. In this embodiment, in terms of division of code areas, the DIMM code areas on the memory stick may be set by the key [0] on the keyboard; and the chip code areas, which are numbered 1-9 and numbered 10-17, may be set by the keys [1]-[9] and the keys [a]-[h], respectively. That is, by pressing the keys [1]-[9] and [a]-[h] down and dragging by the mouse, the code areas are framed. To delete the code areas, the last defined code area may be deleted by the key [r], and all the defined code areas may be deleted by the key [R]. All the currently defined code areas may be saved by the key [s] to form a new code area distribution scheme. Any saved code area distribution may be loaded by the key [I]. In terms of code tests, the code test may be stopped by the key [ESC]. All settings are cancelled. The process enters the setting and waiting state. The code test may be run or stopped by the key [Space]. In terms of system control, the state of devices in the system may be displayed by the key [i], and the devices in the entire system may be shut down by the key [q].

Referring to FIG. 5, in an embodiment, any system in the process control device 50 may read or change the state information of the code acquisition subsystem formed by the transfer track 10, the image capture device 20, the image processing device 30 and the illuminating device 40 through the data storage device 60. The state information may specifically include, but is not limited to, program information, current processing state, current processing state changes, and current code area distribution.

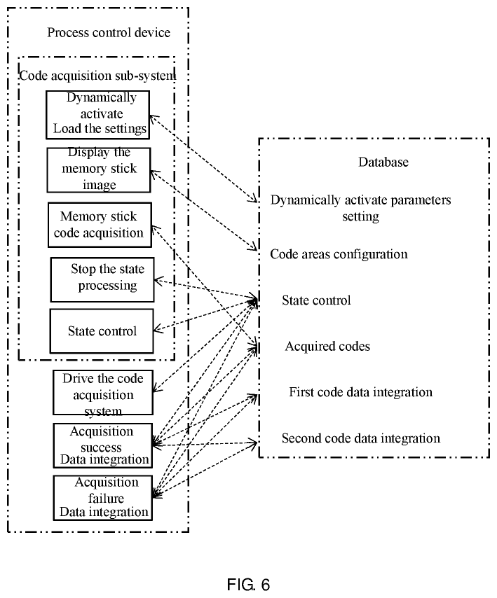

Referring to FIG. 6, in an embodiment, the process control device 50 comprises a process control module 510 and a data integration module 520.

The process control module 510 is electrically connected to the transfer track 10, the image capture device 20, the image processing device 30, and the illuminating device 40, respectively, and configured to control the transfer track 10, the image capture device 20, the image processing device 30, and the illuminating device 40 to start or stop according to a preset process.

The data integration module 520 is electrically connected to the image processing device 30, and configured to receive the identified memory stick codes, determine whether the memory stick codes are successfully identified, and integrate the memory stick codes into the preset form according to the determination result.

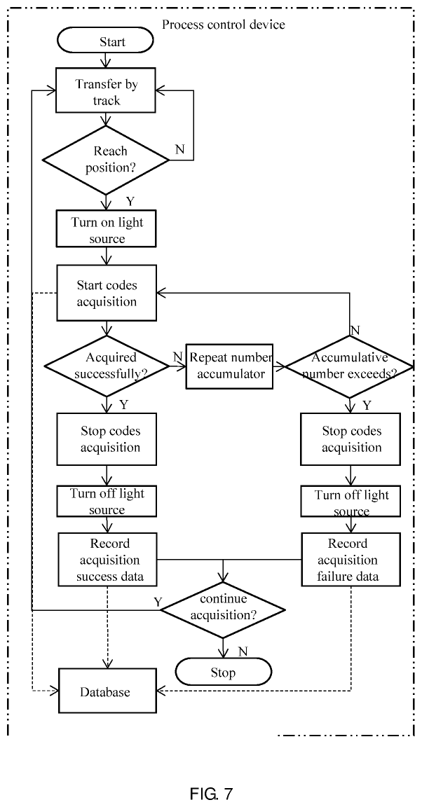

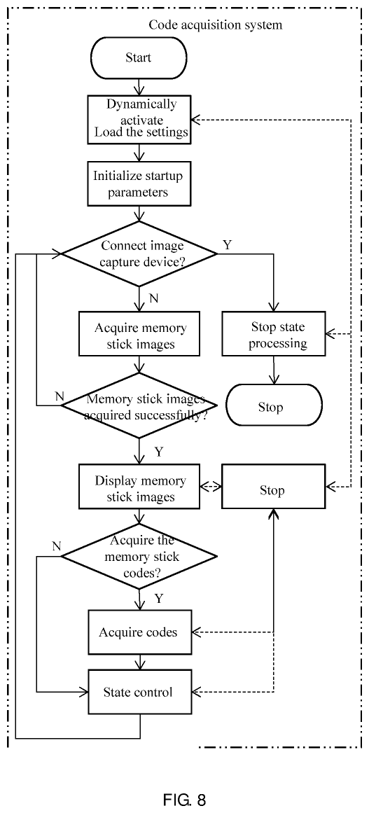

Referring to FIGS. 7-8, in an embodiment, the process control module 510 may start the transfer track 10 before the memory stick reaches the preset shooting position, so as to realize the transfer of the memory stick, otherwise it will pause the transfer of the memory stick. The process control module 510 may turn on the illuminating device 40 after the memory stick is transferred to the shooting position. After the code acquisition is started, the startup parameters may be initialized first to determine whether the image capture device 20 is connected, and the image capture device 20 is used to capture a memory stick image. After the memory stick image is captured, the process control module 510 may turn off the illuminating device 40. After the illuminating device 40 is turned on and the memory stick image is captured, the control state parameters of the image processing device 30 may be updated by directly generating control instructions or changing the data in the data storage device 60, to control the image processing device 30 to acquire the memory stick codes.

In an embodiment, the process control module 510 may further comprise a repetition count accumulator. The repetition count accumulator may be configured to calculate the number of failed acquisitions of codes on a same memory stick. The code acquisition failure means that the memory stick codes in all the code areas on a memory stick are not successfully obtained. In this embodiment, the process control module 510 may shut down the image processing device 30 after the memory stick codes are successfully acquired or the accumulative number of acquisitions exceeds a preset value.

In an embodiment, after the memory stick codes are acquired successfully or unsuccessfully, the data integration module 520 may integrate the acquired data.

When the memory stick codes are acquired successfully, the data of the memory stick codes and their numbers in the acquired code form in the data storage device 60 may be integrated. That is, the memory stick codes and their numbers are added to the first code data integration form (DIMM codes) and the second code data integration form (chip codes), with “Yes” in the field “Successful or Not” in the forms. Finally, the acquired code form may be cleared by controlling the state of the image processing device 30.

When the memory stick codes are acquired unsuccessfully, the data of the memory stick codes and their numbers in the acquired code form in the data storage device 60 may be integrated. That is, the memory stick codes and their numbers are added to the first code data integration form (DIMM codes) and the second code data integration form (chip codes), with “No” in the field “Successful or Not” in the forms. Finally, the acquired code form may be cleared by controlling the state of the image processing device 30.

In an embodiment, the storage forms in the data storage device 60 may refer to Table 1 to Table 6.

TABLE 1
Settings of dynamic startup parameters

| | | | | | | |
|---|---|---|---|---|---|---|
| Element | Field | Field | Field | In- | Primary | Foreign |
| name | name | type | example | put | key | key |

| | | | | | |
|---|---|---|---|---|---|
| Identification | id | digi | 9 | X | * |
| number | | | | | |
| Value | value | alph | Array | Y | |
| Description | des | alph | Chip code | Y | |
| Program | vname | alph | Code chip | Y | |
| variable name | | | | | |
| Program | vtype | alph | string | Y | |
| variable type | | | | | |

TABLE 2
Code area configuration

| | | | | | | |
|---|---|---|---|---|---|---|
| Element | Field | Field | Field | In- | Primary | Foreign |
| name | name | type | example | put | key | key |

| | | | | | |
|---|---|---|---|---|---|
| Identification | id | digi | 4 | X | * |
| number | | | | | |
| Name | name | alph | DLFIA | Y | |
| Value | value | alph | 0; 625; 165; 098; | Y | |
| | | | 284; 1; 965; 234; | | |
| | | | 765; 098; 3; 876; | | |
| | | | 1234; 456; 7890 | | |

TABLE 3
Acquired codes

| | | | | | | |
|---|---|---|---|---|---|---|
| Element | Field | Field | Field | In- | Primary | Foreign |
| name | name | type | example | put | key | key |

| | | | | | |
|---|---|---|---|---|---|
| Area No. | regionID | digi | 9 | Y | * |
| Code | num | alph | 12345678912345 | Y | |

TABLE 4
State control

| | | | | | | |
|---|---|---|---|---|---|---|
| Element | Field | Field | Field | In- | Primary | Foreign |
| name | name | type | example | put | key | key |

| | | | | | |
|---|---|---|---|---|---|
| Identification | id | digi | 4 | X | * |
| number | | | | | |
| Value | value | alph | Null | Y | |
| Description | des | alph | Chip code | Y | |

TABLE 5
First code data integration

| | Field | Field | Field | | Primary | Foreign |
|---|---|---|---|---|---|---|
| Element name | name | type | example | Input | key | key |
| DIMM | id_dimm | digi2 | 6 | X | * | * |
| identification number | | | | | | |
| Create time | ctime | timelabel | 2020-4-11 15:21:01 | Y | | |
| DIMM codes | cdimm | alph | 20200411006910103 | Y | | |
| Successful or not | pass | boolean | Yes | Y | | |

TABLE 6
Second code data integration

| | | | | | | |
|---|---|---|---|---|---|---|
| | | | | | Pri- | For- |
| Element | Field | Field | Field | In- | mary | eign |
| name | name | type | example | put | key | key |

| | | | | | |
|---|---|---|---|---|---|
| Chip | id_chip | digi2 | 13 | X | * |
| identi- | | | | | |
| fication | | | | | |
| number | | | | | |
| Create | ctime | timelabel | 2020-4-11 | Y | |
| time | | | 15:21:01 | | |
| Chip No. | nchip | digi | 5 | Y | |
| Chip | cchip | alph | 12345678912345 | Y | |
| codes | | | | | |
| Successful | pass | boolean | Yes | Y | |
| or not | | | | | |
| DIMM | id_dimm | digi2 | 2 | Y | |
| No. | | | | | |

In an embodiment, the code acquisition system 100 further comprises a data storage device 60. The data storage device 60 is electrically connected to the process control device 50 and the image processing device 30, respectively, and configured to store preset processes, memory stick codes, and preset forms.

In an embodiment, the data storage device 60 may be, but is not limited to, a hardware device, for example, data storage in a computer device, that is, a database. The data storage device 60 may be used for state communication and data access between the process control device 50 and the transfer track 10, image capture device 20, image processing device 30, and illuminating device 40. By providing the data storage device 60, it is possible to store the data of the integrated memory stick codes. It is convenient to query for the memory code data.

Based on the same inventive concept, the present application further provides a code acquisition method. The code acquisition method comprises:

S10: pre-loading the types, sizes and positions of memory stick codes;

S20: dividing into code areas according to the types, sizes and positions of the memory stick codes;

S30: transferring memory stick to preset positions;

S40: capture memory stick images; and

S50: identifying the memory stick codes according to the code areas and the memory stick images.

It may be understood that the code acquisition method may be applied to the code acquisition system 100 in any of the above embodiments, and will not be repeated herein.

Various technical features of the above embodiments can be arbitrarily combined. For simplicity, all possible combinations of various technical features of the above embodiments are not described. However, all those technical features shall be included in the protection scope of the present invention if not conflict.

The embodiments described above merely represent certain implementations of the present application. Although those embodiments are described in more specific details, it is not to be construed as any limitation to the scope of the present application. It should be noted that, for a person of ordinary skill in the art, a number of variations and improvements may be made without departing from the concept of the present application, and those variations and improvements should be regarded as falling into the protection scope of the present application. Therefore, the protection scope of the present application should be subject to the appended claims.

1. A code acquisition system, comprising:
a transfer track, configured to transfer memory sticks and limit the positions and placement directions of the memory sticks;
an image capture device, configured to capture memory stick images; and
an image processing device, comprising: a code area definition module configured to divide into code areas according to types, sizes and positions of pre-loaded memory stick codes; and a code identification module electrically connected to the image capture device and the code area definition module respectively, and configured to receive the memory stick images and identify the memory stick codes according to the memory stick images and the code areas.

2. The code acquisition system according to claim 1, further comprising: an illuminating device, configured to provide light for capture process of the memory stick images.

3. The code acquisition system according to claim 2, wherein a light outgoing direction of the illuminating device is parallel to a transfer plane of the transfer track and perpendicular to a extension direction of the transfer track.

4. The code acquisition system according to claim 1, wherein the code identification module comprises:
an image magnification unit, electrically connected to the image capture device and the code area definition module respectively, and configured to magnify different code areas of the memory stick images to different preset multiples; and
an image identification unit, electrically connected to the image magnification unit, and configured to identify codes in the different code areas magnified of the memory stick images.

5. The code acquisition system according to claim 4, wherein the code identification module further comprises:
an image cutting unit, electrically connected to the image capture device; the code area definition module and the image magnification unit respectively, and configured to cut the memory stick images according to the code areas and send the cut memory stick images to the image magnification unit.

6. The code acquisition system according to claim 5, wherein the code identification module further comprises:
an image preprocessing unit electrically connected to the image capture device and the image cutting unit respectively, and configured to convert the memory stick images into grayscale images and send the grayscale images to the image cutting unit; and
an image binarization unit, electrically connected to the image magnification unit and the image identification unit respectively, and configured to binarize the magnified memory stick images and send the binarized memory stick images to the image identification unit.

7. The code acquisition system according to claim 2, further comprising: a process control device, electrically connected to the transfer track, the image capture device, the image processing device, and the illuminating device respectively, and configured to control the transfer track, the image capture device, the image processing device, and the illuminating device to start or stop according to a preset process, receive the identified memory stick codes, and integrate the memory stick codes into a preset form.

8. The code acquisition system according to claim 7, wherein the process control device comprises:
a process control module, electrically connected to the transfer track, the image capture device, the image processing device, and the illuminating device, respectively, and configured to control the transfer track, the image capture device, the image processing device, and the illuminating device to start or stop according to a preset process; and
a data integration module, electrically connected to the image processing device, and configured to receive the identified memory stick codes, determine whether the memory stick codes are successfully identified, and integrate the memory stick codes into the preset form according to a determination result.

9. The code acquisition system according to claim 7, further comprising: a data storage device, electrically connected to the process control device and the image processing device, respectively, and configured to store the preset process, the memory stick codes and the preset form.

10. The code acquisition system according to claim 8, wherein a light outgoing direction of the illuminating device is parallel to a transfer plane of the transfer track.

11. The code acquisition system according to claim 6, wherein the image binarization unit obtains an adaptive threshold by a Maximum Between-Class Variance method among binarization methods, and converts grayscale images of the memory sticks into binary images according to the adaptive threshold.

12. The code acquisition system according to claim 7, wherein, before controlling the transfer track, the image capture device, the image processing device, and the illuminating device to start according to the preset process, the process control device sets desired startup parameters and loads pre-configured startup parameters.

13. The code acquisition system according to claim 12, wherein the startup parameters comprise camera parameters, system control parameters, or system detection parameters.

14. A code acquisition method, comprising:
pre-loading the types, sizes and positions of memory stick codes;
dividing into code areas according to the types, sizes and positions of the memory stick codes;
transferring memory stick to preset positions;
capture memory stick images; and
identifying the memory stick codes according to the code areas and the memory stick images.
